(19) United States
(12) Patent Application Publication
(10) Pub. No.: US 2012/0092232 A1
(43) Pub. Date: Apr. 19, 2012

(54) Sending Video Data to Multiple Light Modulators

(75) Inventors: Thomas Lawrence Burnett, Austin, TX (US); Salah U. Din, Austin, TX (US); Shih-Che Huang, Austin, TX (US); Kendall James, Austin, TX (US); Mark E. Lucente, Austin, TX (US)

(73) Assignee: ZEBRA IMAGING, INC., Austin, TX (US)

(21) Appl. No.: 12/983,276

(22) Filed: Dec. 31, 2010

Related U.S. Application Data
(60) Provisional application No. 61/393,350, filed on Oct. 14, 2010.

(51) Int. Cl. G09G 5/00

(52) U.S. Cl. 345/1.1

(57) ABSTRACT

Methods and systems for sending video data, including generating video data comprising video elements using a graphics processor, the video data being configured to be displayed on multiple displays, and encoding metadata into the video elements, the metadata comprising information indicating a correspondence between the video data and the multiple displays.

### A. PRIORITY

This application claims priority from:

U.S. Provisional Application No. 61393350, filed 14-OCT-2010, entitled “Sending Video Data to Multiple Light Modulators” and naming Shih-Che Huang, et. al, as inventor(s).

The above-referenced patents and/or patent applications are hereby incorporated by reference herein in their entirety.

### B. BACKGROUND

The invention relates generally to the field of sending video data to multiple light modulators.

### C. SUMMARY

In one respect, disclosed is a method for sending video data, the method comprising generating video data comprising video elements using a graphics processor, the video data being configured to be displayed on multiple light modulators, encoding metadata into the video elements, the metadata comprising information indicating a correspondence between the video data and the multiple light modulators.

In another respect, disclosed is a system for system for sending video data, the system comprising one or more processors, one or more memory units coupled to the one or more processors, the system being configured to generate video data comprising video elements using a graphics processor, the video data being configured to be displayed on multiple light modulators, encode metadata into the video elements, the metadata comprising information indicating a correspondence between the video data and the multiple light modulators.

In yet another respect, disclosed is a computer program product embodied in a computer-operable medium, the computer program product comprising logic instructions, the logic instructions being effective to generate video data comprising video elements using a graphics processor, the video data being configured to be displayed on multiple light modulators, and encode metadata into the video elements, the metadata comprising information indicating a correspondence between the video data and the multiple light modulators.

Numerous additional embodiments are also possible.

### D. BRIEF DESCRIPTION OF THE DRAWINGS

Other objects and advantages of the invention may become apparent upon reading the detailed description and upon reference to the accompanying drawings.

FIG. 1 is a block diagram illustrating a system for sending video data to multiple light modulators, in accordance with some embodiments.

FIG. 2 is a block diagram illustrating a system for sending video data to multiple light modulators using a display driver, in accordance with some embodiments.

FIG. 3 is a block diagram illustrating a system for sending video data from multiple graphics processors to multiple light modulators using a display driver, in accordance with some embodiments.

FIG. 4 is a flow diagram illustrating a method for sending video data to multiple light modulators, in accordance with some embodiments.

FIG. 5 is a flow diagram illustrating an alternative method for sending video data to multiple light modulators, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### E. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

In some embodiments, systems and methods for sending video data are disclosed. In some embodiments video data comprising video elements may be generated. The video data may be of various types, including video data for 2D displays and video data for 3D displays. It should also be noted that still images data may be used in place of the video data as described here.

In embodiments where 2D video data is generated, the video elements may be pixels, for example. In embodiments where 3D video data is generated, the video elements may be hogels or subhogels (such as hogel/light beams or pixels in cases where the hogels are generated using pixel-based displays). For more information on hogel displays or hogel light modulators, please see:
U.S. patent application Ser. No. 12/258,438, filed 26-OCT-2008, titled “Systems and Methods for Calibrating a Hogel Display,” and naming Mark E. Lucente as inventor,
U.S. patent application Ser. No. 11/834,005, filed Aug. 5, 2007, titled “DYNAMIC AUTOSTEREOSCOPIC DISPLAYS,” and naming Mark E. Lucente et al. as inventors,
U.S. patent application Ser. No. 11/724,832, filed Mar. 15, 2007, titled “DYNAMIC AUTOSTEREOSCOPIC DISPLAYS,” and naming Mark E. Lucente et al. as inventors,
U.S. Provisional Application No. 60/782,345, filed Mar. 15, 2006, entitled “Active Autostereoscopic Emissive Displays,” and naming Mark Lucente, et. al, as inventors.

The above-referenced patents and/or patent applications are hereby incorporated by reference herein in their entirety.

In some embodiments, the video elements may be generated using a graphics processing unit and may be configured to be displayed on multiple light modulators. In some embodiments, metadata may be encoded into some or all of the video elements. Metadata corresponding to a group of video elements may be encoded and/or distributed across one or a subset of the video elements in that group. In some embodiments, the metadata may include information indicating a correspondence between the video data and the multiple light modulators.

In some embodiments, the video data, along with the metadata, may be sent to all or at least a subset of the light modulators. The light modulators may be configured to receive the video data and the metadata and to determine which of the video data is to be displayed by which light modulator. In alternative embodiments, one or more logic units attached to the light modulators may be configured to receive the video data and the metadata, determine which of the light modulators is to display the video data, and send the corresponding video data to that light modulator.

In some embodiments, the video data may be generated using additional graphics processing units, such that different portions of each frame of the video data may be generated using different graphics processing units. In these embodiments, each of the graphics processing units may generate video data encoded with metadata. The metadata may include information indicating a correspondence between the video data and the multiple light modulators.

In some embodiments, the metadata may be stored in graphics elements, which, for various reasons, may not be displayed by the light modulators. For example, in pixel-based hogel light modulators, circular hogels may be used leaving unused pixels in between the circular hogels. The unused may be used to carry the metadata information. For example, one or more of the unused pixels may carry information that is specific to the video data and light modulator corresponding to the unused pixels.

In some embodiments, metadata may also include additional information such as video sync information, light modulator color response, light modulator backlight levels, etc. Other information may also be included such as protocol version information, error information, calibration information, type of data,

In some embodiments, two-way communication may be established between the one or more graphics processing units and the multiple displays in order to facilitate additional functionality for the system.

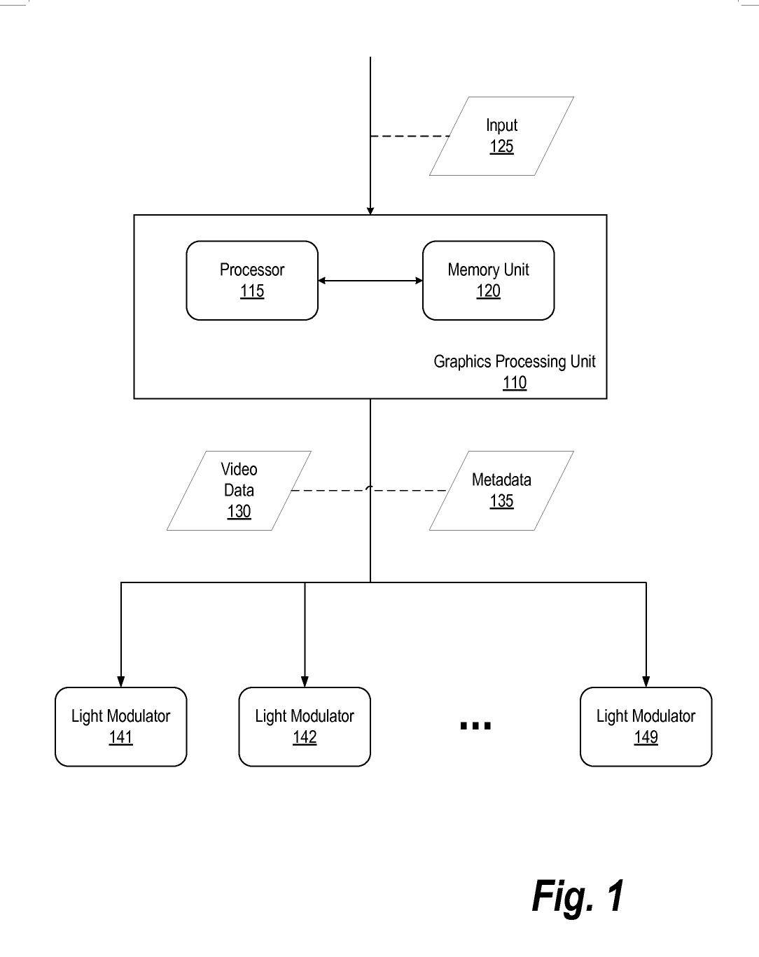

FIG. 1 is a block diagram illustrating a system for sending video data to multiple light modulators, in accordance with some embodiments.

In some embodiments, graphics processing unit 110 is configured to receive input 125. Input 125 may be 3D data and commands, for example, and graphics processing unit 110 may be configured to render/convert/process input 125 into video data 130. In some embodiments, graphics processing unit 110 may be implemented using processor 115 and memory unit 120.

In some embodiments, video data 130 may comprise video elements (such as pixels, hogels or subhogels, light beams, etc.). Metadata 135 may be encoded into the video elements of video data 130. In some embodiments, metadata 135 may comprise information indicating a correspondence between the video data and multiple light modulators.

In some embodiments, the video data 130 and metadata 135 may be sent to all or at least a subset of light modulators 141, 142, . . . , & 149. The light modulators may be configured to receive the video data and the metadata and to determine which of the video data is to be displayed by which light modulator.

In some embodiments, light modulators 141, 142, . . . , & 149 may comprise one or more memory units in order to buffer data received by the graphics processing unit 110.

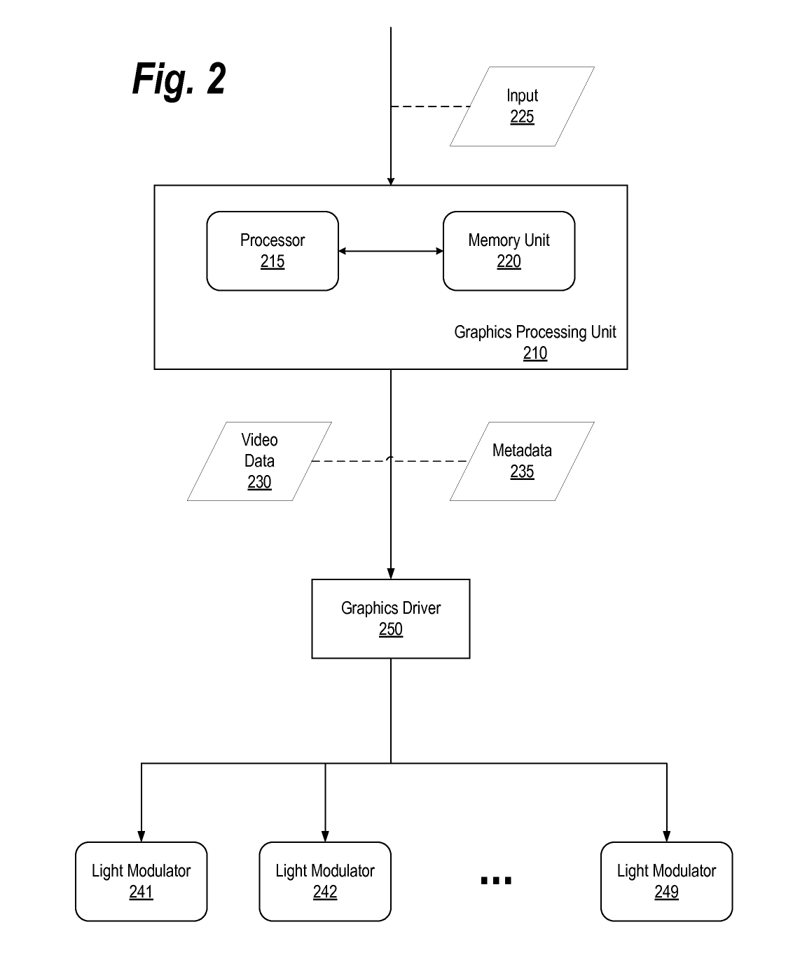

FIG. 2 is a block diagram illustrating a system for sending video data to multiple light modulators using a display driver, in accordance with some embodiments.

In some embodiments, graphics processing unit 210 is configured to receive input 225. Input 225 may be 3D data and commands, for example, and graphics processing unit 210 may be configured to render/convert/process input 225 into video data 230. In some embodiments, graphics processing unit 210 may be implemented using processor 215 and memory unit 220.

In some embodiments, video data 230 may comprise video elements (such as pixels, hogels, light beams, etc.). Metadata 235 may be encoded into the video elements of video data 230. In some embodiments, metadata 235 may comprise information indicating a correspondence between the video data and multiple light modulators.

In some embodiments, video data 230 and metadata 235 may be sent to graphics driver 250. Graphics driver 250 is configured to receive the video data 230 and to determine, using metadata 235, to which one of light modulators 241, 242, . . . , & 249 to send which portion of video data 230. Graphics driver 250 may determine which portion of video data 230 to send to which one of light modulators 241, 242, . . . , & 249 using the correspondence information in metadata 235.

In some embodiments, graphics driver 250 and/or light modulators 241, 242, . . . , & 249 may comprise one or more memory units in order to buffer received video data.

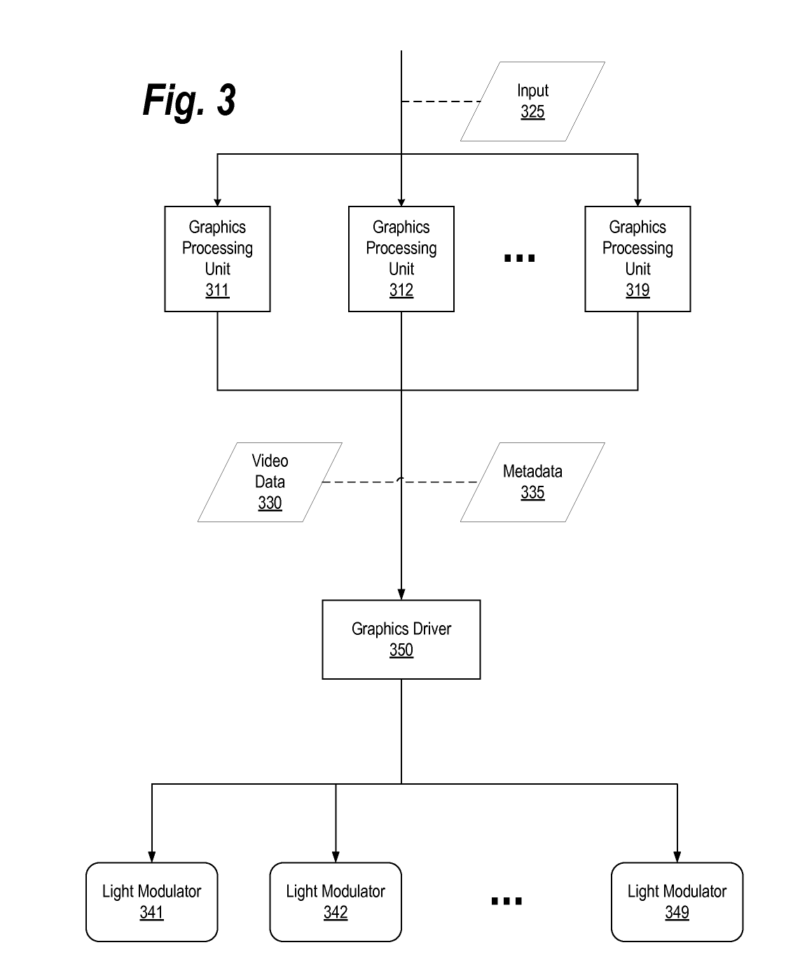

FIG. 3 is a block diagram illustrating a system for sending video data from multiple graphics processors to multiple light modulators using a display driver, in accordance with some embodiments.

In some embodiments, graphics processing units 311, 312, . . . , & 319 are configured to receive input 325. Input 325 may be 3D data and commands, for example, and graphics processing units 311, 312, . . . , & 319 may be configured to render/convert/process input 325 into video data 330. In some embodiments, one or more of graphics processing units 311, 312, . . . , & 319 may be implemented using processor 315 and memory unit 320.

In some embodiments, video data 330 may comprise video elements (such as pixels, hogels or subhogels, light beams, etc.). Metadata 335 may be encoded into the video elements of video data 330. In some embodiments, metadata 335 may comprise information indicating a correspondence between the video data generated by graphics processing units 311, 312, . . . , & 319 and light modulators 341, 342, . . . , & 349.

In some embodiments, video data 330 and metadata 335 from all the graphics processor units may be sent to graphics driver 350. Graphics driver 350 is configured to receive the video data 330 and to determine, using metadata 335, to which one of light modulators 341, 342, . . . , & 349 to send which portion of video data 330. Graphics driver 350 may determine which portion of video data 330 to send to which one of light modulators 341, 342, . . . , & 349 using the correspondence information in metadata 335.

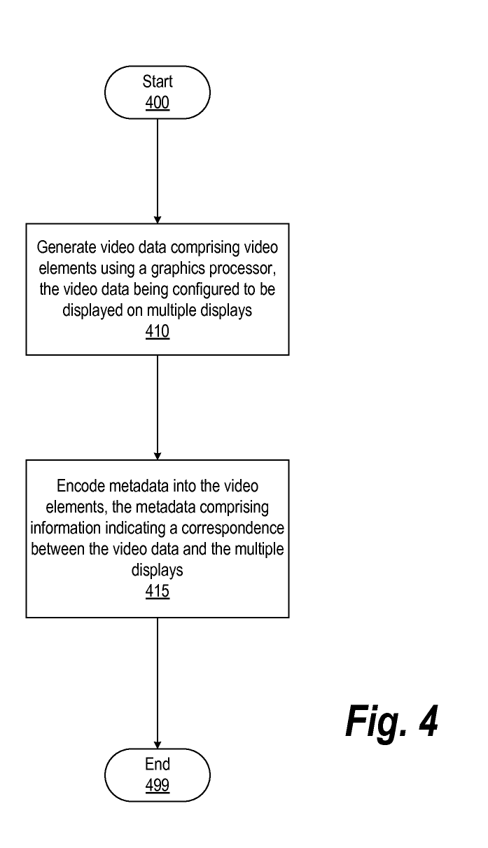

FIG. 4 is a flow diagram illustrating a method for sending video data to multiple light modulators, in accordance with some embodiments.

In some embodiments, the method illustrated in this figure may be performed by one or more of the systems illustrated in FIG. 1, FIG. 2, and FIG. 3.

Processing begins at 400 whereupon, at block 410, video data is generated comprising video elements using a graphics processor, the video data being configured to be displayed on multiple displays.

At block 415, metadata is encoded into the video elements, the metadata comprising information indicating a correspondence between the video data and the multiple displays.

Processing subsequently ends at 499.

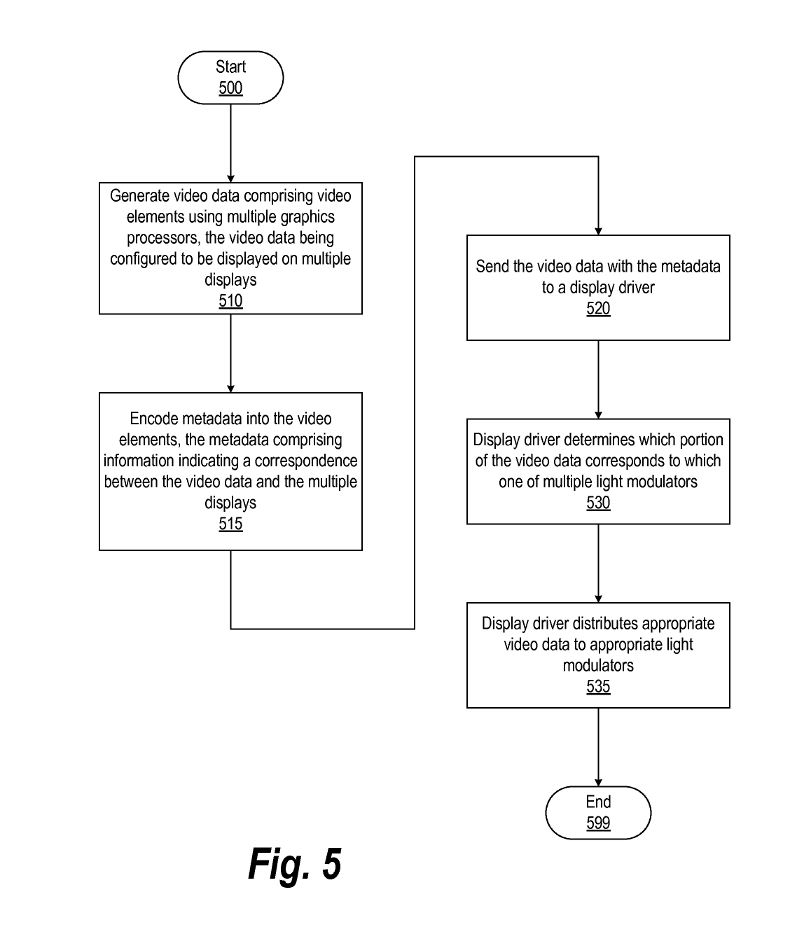

FIG. 5 is a flow diagram illustrating an alternative method for sending video data to multiple light modulators, in accordance with some embodiments.

In some embodiments, the method illustrated in this figure may be performed by one or more of the systems illustrated in FIG. 1, FIG. 2, and FIG. 3.

Processing begins at block 500 whereupon, at block 510, video data is generated comprising video elements using multiple graphics processors, the video data being configured to be displayed on multiple displays.

At block 515, metadata is encoded into the video elements, the metadata comprising information indicating a correspondence between the video data and the multiple displays. In some embodiments, the correspondence may indicate which of the video elements are to be displayed on which display. Video elements may be pixels, hogels, etc.

At block 520, video data is sent with the metadata to a display driver.

At block 530, the display driver determines which portion of the video data corresponds to which one of multiple light modulators.

At block 535, the display driver distributes appropriate video data to appropriate light modulators.

Processing subsequently ends at 599.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method for sending video data, the method comprising:
generating video data comprising video elements using a graphics processor, the video data being configured to be displayed on multiple displays;
encoding metadata into the video elements, the metadata comprising information indicating a correspondence between the video data and the multiple displays.

2. The method of claim 1, further comprising sending the video data to the multiple displays using a graphics output of the graphics processor.

3. The method of claim 1, where the video data is hogel data and where the video elements are hogels or subhogels.

4. The method of claim 3, where the metadata is stored within unused hogels or subhogels.

5. The method of claim 1, further comprising:
generating additional video data comprising video elements using additional graphics processors, the additional video data being configured to be displayed on multiple displays;
encoding additional metadata into the additional video elements, the additional metadata comprising information indicating a correspondence between the additional video data and the multiple displays;
sending the video data and the additional video data to the multiple displays using additional graphics outputs on the additional graphics processors.

6. The method of claim 1, where the metadata comprises information indicating at least one of:
video sync information;
light modulator color response;
light modulator backlight levels;
version information;
frame number;
version information;
multiplexing information; and
color modes.

7. A system for sending video data, the system comprising:
one or more processors;
one or more memory units coupled to the one or more processors;
the system being configured to:
generate video data comprising video elements using a graphics processor, the video data being configured to be displayed on multiple displays;
encode metadata into the video elements, the metadata comprising information indicating a correspondence between the video data and the multiple displays.

8. The system of claim 8, the system being further configured to send the video data to the multiple displays.

9. The system of claim 8, where the video data is hogel data and where the video elements are hogels or subhogels.

10. The system of claim 9, where the metadata is stored within unused hogels or subhogels.

11. The system of claim 8, the system being further configured to:
generate additional video data comprising video elements using additional graphics processors, the additional video data being configured to be displayed on multiple displays;
encode additional metadata into the additional video elements, the additional metadata comprising information indicating a correspondence between the additional video data and the multiple displays;
send the video data and the additional video data to the multiple displays.

12. The system of claim 8, where the metadata comprises information indicating at least one of:
video sync information;
light modulator color response;
light modulator backlight levels;
version information;
frame number;
version information;
multiplexing information; and
color modes.

13. A computer program product embodied in a computer-operable medium, the computer program product comprising logic instructions, the logic instructions being effective to:
generate video data comprising video elements using a graphics processor, the video data being configured to be displayed on multiple displays;
encode metadata into the video elements, the metadata comprising information indicating a correspondence between the video data and the multiple displays.

14. The product of claim 13, the code being further effective to send the video data to the multiple displays.

15. The product of claim 13, where the video data is hogel data and where the video elements are hogels or subhogels.

16. The product of claim 15, where the metadata is stored within unused hogels or subhogels.

17. The product of claim 13, the code is further effective to:
generate additional video data comprising video elements using additional graphics processors, the additional video data being configured to be displayed on multiple displays;
encode additional metadata into the additional video elements, the additional metadata comprising information indicating a correspondence between the additional video data and the multiple displays;
send the video data and the additional video data to the multiple displays.

18. The product of claim 13, where the metadata comprises information indicating at least one of:
video sync information;
light modulator color response;
light modulator backlight levels;
version information;
frame number;
version information;
multiplexing information; and
color modes.
